(19) United States
(12) Patent Application Publication
(10) Pub. No.: US 2026/0298155 A1
(43) Pub. Date: Oct. 1, 2026

(54) CONTROL DEVICE, MOVING OBJECT, CONTROL METHOD, AND STORAGE MEDIUM

(71) Applicant: HONDA MOTOR CO., LTD., Tokyo (JP)

(72) Inventor: Yudai Suzuki, Wako-shi (JP)

(21) Appl. No.: 19/630,790

(22) Filed: Mar. 27, 2026

(30) Foreign Application Priority Data
Mar. 31, 2025 (JP) 2025-058075

(51) Int. Cl. F02C 9/26

(52) U.S. Cl. CPC F02C 9/26; F05D 2220/76

(57) ABSTRACT

A control device includes a torque determination unit that determines whether or not a motoring torque of a power generator is less than a predetermined torque threshold, after control to cut off supply of fuel has been performed, a stopped-state determination unit that determines whether or not a gas turbine engine has reached a stopped state, when the torque determination unit determines that the motoring torque of the power generator is less than the torque threshold, and an abnormality determination unit that determines that an abnormality exists in a shutoff valve, when the stopped-state determination unit determines that the gas turbine engine has not reached the stopped state.

### CROSS-REFERENCE TO RELATED APPLICATIONS

This application is based upon and claims the benefit of priority from Japanese Patent Application No. 2025-058075 filed on Mar. 31, 2025, the contents of which are incorporated herein by reference.

### BACKGROUND OF THE INVENTION

### Field of the Invention

The present disclosure relates to a control device, a moving object, a control method, and a storage medium.

### Description of the Related Art

JP 2001-107750 A discloses a control system for a gas turbine engine. The control system may operate the shutoff valve to block supply of fuel to the fuel nozzles.

### SUMMARY OF THE INVENTION

There is a need to reliably inspect shutoff valves.

The present disclosure has the object of satisfying the aforementioned need.

A first aspect of the present disclosure is a control device provided in a power generation system including a power generator, a gas turbine engine that drives the power generator, and a power conversion device that converts alternating-current power output from the power generator into direct-current power, the control device including: a valve control unit configured to control a shutoff valve to cut off supply of fuel to the gas turbine engine; a torque determination unit configured to determine whether or not a motoring torque of the power generator is less than a predetermined torque threshold, after control to cut off the supply of fuel has been performed; a stopped-state determination unit configured to determine whether or not the gas turbine engine has reached a stopped state in a case where the torque determination unit determines that the motoring torque of the power generator is less than the torque threshold; and a abnormality determination unit configured to determine that an abnormality exists in the shutoff valve in a case where the stopped-state determination unit determines that the gas turbine engine has not reached the stopped state.

A second aspect of the present disclosure is a moving object including a power generation system including the control device of the first aspect.

A third aspect of the present disclosure is a control method for a power generation system including a power generator, a gas turbine engine that drives the power generator, and a power conversion device that converts alternating-current power output from the power generator into direct-current power, the control method including: a valve control step of causing one or more processors to control a shutoff valve to thereby cut off supply of fuel to the gas turbine engine; a torque determination step of causing the one or more processors to determine whether or not a motoring torque of the power generator is less than a predetermined torque threshold, after the valve control step has been performed; a stopped-state determination step of causing the one or more processors to determine whether or not the gas turbine engine has reached a stopped state, in a case where it is determined in the torque determination step that the motoring torque of the power generator is less than the torque threshold; and an abnormality determination step of causing the one or more processors to determine that an abnormality exists in the shutoff valve, in a case where it is determined in the stopped-state determination step that the gas turbine engine has not reached the stopped state.

A fourth aspect of the present disclosure is a program for causing a computer to execute the control method of the third aspect.

According to the present disclosure, it is possible to suitably inspect a shutoff valve.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a moving object;

FIG. 2 is a schematic diagram of a power generation system;

FIG. 3 is a circuit diagram of a PCU;

FIG. 4 is a control block diagram of a control device; and

FIG. 5 is a flowchart of an inspection process of a shutoff valve.

### DETAILED DESCRIPTION OF THE INVENTION

With the electrification of moving objects (mobile bodies), power generation systems in which a gas turbine engine and a power generator are coupled have been developed. Generally, a shutoff valve is provided in a fuel supply path to a gas turbine engine. When the shutoff valve is actuated, the supply of fuel to the gas turbine engine is cut off, so that the gas turbine engine can be stopped.

When a moving object equipped with the power generation system is stopped, the shutoff valve is inspected. In an inspection of the shutoff valve, it is determined whether the gas turbine engine properly stops after actuation of the shutoff valve. When the shutoff valve operates normally, fuel supply to the gas turbine engine is cut off. As the fuel supply is cut off, the rotational speed of the output shaft of the gas turbine engine gradually decreases.

However, when the rotational speed of the output shaft of the gas turbine engine is decreasing, the power generator may be in a motoring state (which will be also referred to as a power running state). When the motoring torque (which will be also referred to as the power running torque) of the power generator is large, even if the shutoff valve is actuated, it takes time until the rotation of the output shaft of the gas turbine engine is stopped. If the shutoff valve is inspected in this state, a correct determination result cannot be obtained. The present disclosure enables a shutoff valve to be inspected correctly.

### 1. Moving Object 100

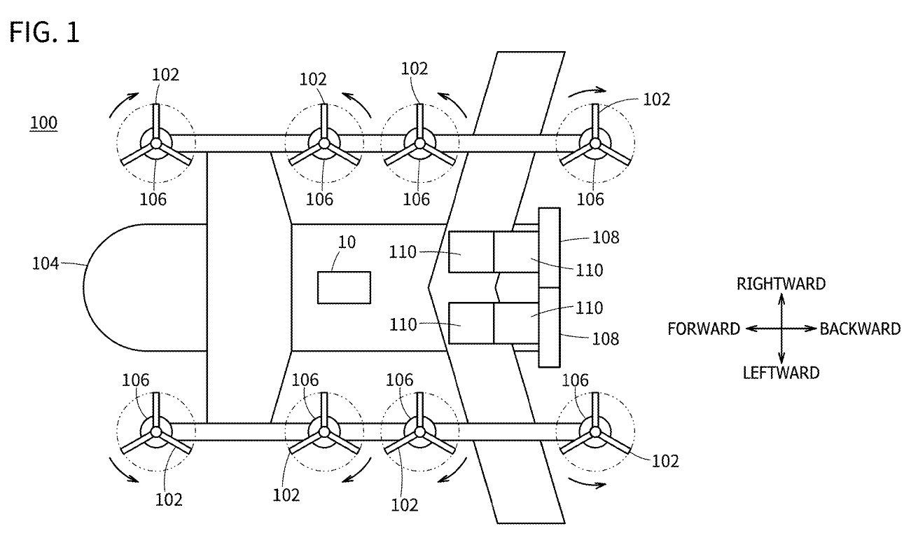

FIG. 1 is a schematic view of a moving object 100. The moving object baccording to an embodiment is an electric vertical take-off and landing aircraft (eVTOL aircraft). The moving object 100 includes eight VTOL rotors 102. The VTOL rotor 102 generates thrust in the upward direction with respect to the airframe 104. The moving object 100 includes eight electric motors 106. One electric motor 106 drives one VTOL rotor 102. The moving object 100 includes two cruise rotors 108. The cruise rotor 108 generates thrust in the forward direction with respect to the airframe 104. The moving object 100 includes two electric motors 110. Two electric motors 110 drive one cruise rotor 108. The moving object 100 includes one or more power generation systems 10. The moving object 100 is not limited to an aircraft, and may be a ship, an automobile, a train, or the like.

### 2. Configuration of Power Generation System 10

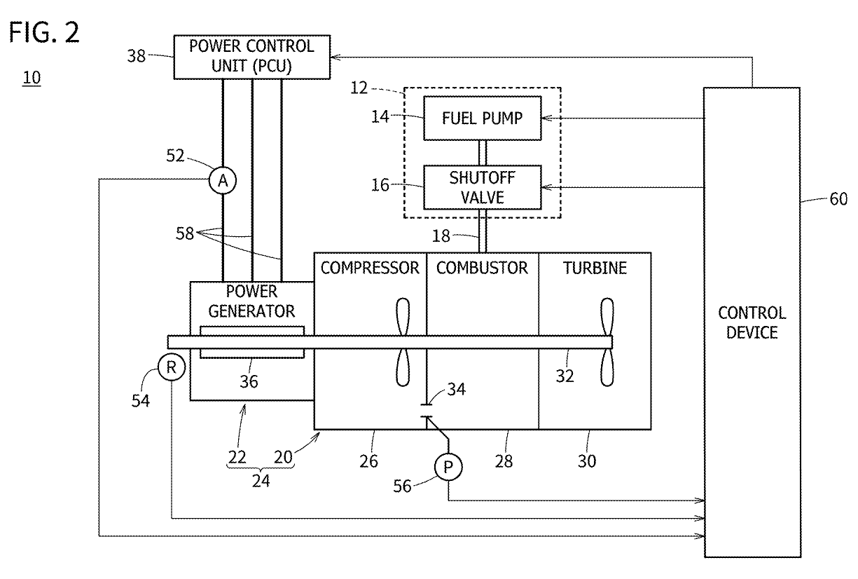

FIG. 2 is a schematic diagram of the power generation system 10. Electric power output from the power generation system 10 is supplied to each electric motor 106 and each electric motor 110 shown in FIG. 1.

The power generation system 10 includes a fuel supply unit 12. The fuel supply unit 12 includes a fuel pump 14 and a shutoff valve 16. The fuel pump 14 is connected to a combustor 28 provided in a gas turbine engine 20 via a fuel supply path 18. The shutoff valve 16 is disposed in the fuel supply path 18.

The fuel pump 14 is provided in a fuel tank (not shown). The fuel pump 14 is, for example, an electric pump. The fuel pump 14 can rotate in a forward direction and a reverse direction. The fuel pump 14 rotates in the forward direction to thereby suck fuel in the fuel tank and pump the sucked fuel to the fuel supply path 18. The fuel pump 14 rotates in the reverse direction to thereby recover fuel remaining in the fuel supply path 18 and return the recovered fuel into the fuel tank.

The shutoff valve 16 can open and close the fuel supply path 18. The shutoff valve 16closes the fuel supply path 18 to cut off the flow of fuel in the fuel supply path 18. The shutoff valve 16can cut off the supply of fuel from the fuel pump 14 to the combustor 28 provided in the gas turbine engine 20 via the fuel supply path 18.

The power generation system 10 includes a gas turbine engine 20 and a power generator 22. The gas turbine engine 20 and the power generator 22 constitute a power generation unit 24. The gas turbine engine 20 and the power generator 22 are integrally formed. The gas turbine engine 20 includes a compressor 26, the combustor 28, and a turbine 30. The compressor 26 compresses outside air sucked therein and discharges the compressed air from an outlet 34. The combustor 28 combusts a mixed gas of air discharged from the outlet 34 of the compressor 26 and fuel supplied from the fuel supply path 18. The turbine 30 is rotated by a high-temperature gas generated by combustion of the mixed gas. An output shaft 32 of the gas turbine engine 20 is connected to a rotor 36 of the power generator 22, and passes through the power generator 22. The power generator 22 is a motor generator that can also function as an electric motor. The power generator 22 outputs, for example, three-phase alternating-current (AC) power.

The power generation system 10 includes a power control unit (power conversion device) 38. The power control unit 38 may function as an AC-DC (direct-current) converter and an inverter. In the present specification, the power control unit 38 is also referred to as a PCU (Power Control Unit) 38. The primary-side terminals of the PCU 38 are connected to the output terminals of the power generator 22. The secondary-side terminals of the PCU 38 are connected to the terminals of a load device (not shown), the terminals of a power storage device (not shown), and the like. The PCU 38 may convert three-phase alternating current power input from the primary side into direct-current (DC) power and output the DC power to the secondary side. The PCU 38 may convert DC power input from the secondary side into three-phase AC power and output the three-phase AC power to the primary side.

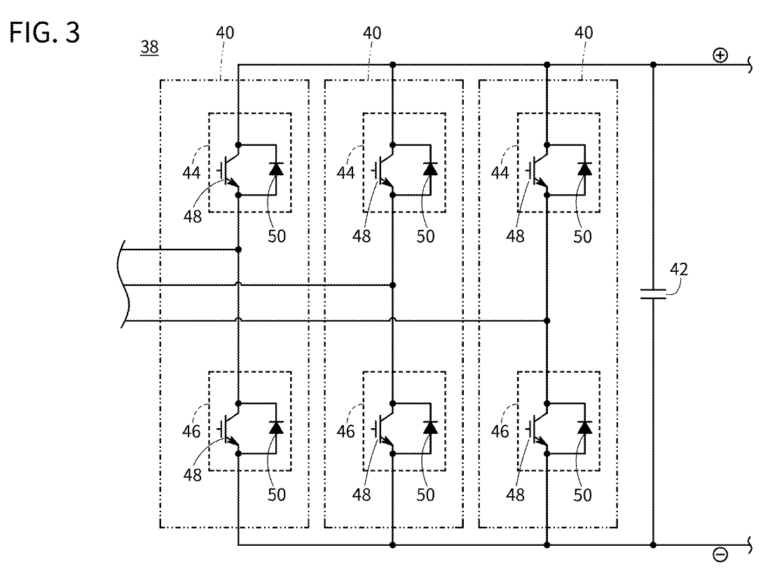

FIG. 3 is a circuit diagram of the PCU 38. The PCU 38 includes three power element units 40 corresponding to the three-phase voltages output from the power generator 22, and a smoothing capacitor 42. The three power element units 40 have the same configuration.

The power element unit 40 includes an upper arm 44 and a lower arm 46. Each of the upper arm 44 and the lower arm 46 includes a switching element 48 and a diode 50. In the power element unit 40, the switching element 48 of the upper arm 44 and the switching element 48 of the lower arm 46 are connected in series with each other. A first end of the switching element 48 of the upper arm 44 is connected to the positive wiring of the PCU 38. A second end of the switching element 48 of the upper arm 44 and a first end of the switching element 48 of the lower arm 46 are connected to one of the three-phase terminals of the power generator 22. A second end of the switching element 48 of the lower arm 46 is connected to the negative wiring of the PCU 38. The anode of the diode 50 is connected to the second end of the switching element 48. The cathode of the diode 50 is connected to the first end of the switching element 48.

The power generation system 10 includes a current sensor 52, a rotational speed sensor 54, and a pressure sensor 56. The current sensor 52 detects electric current flowing through one of the three wires 58 connecting the power generator 22 and the PCU 38. The rotational speed sensor 54 is attached to an end portion of the power generator 22. The rotational speed sensor 54 detects the rotational speed of the output shaft 32 of the gas turbine engine 20 protruding from the power generator 22. The pressure sensor 56 detects the pressure at the outlet 34 of the compressor 26 provided in the gas turbine engine 20.

### 3. Control Device 60

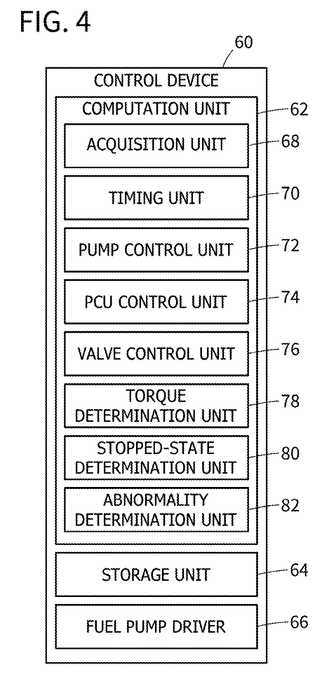

The power generation system 10 includes a control device 60. FIG. 4 is a control block diagram of the control device 60. The control device 60 is configured by, for example, an electronic control unit (ECU).

The control device 60 includes a computation unit 62, a storage unit 64, and a fuel pump driver 66. The computation unit 62 is, for example, a processor such as a central processing unit (CPU), a graphics processing unit (GPU), or the like. The computation unit 62 includes an acquisition unit 68, a timing unit 70, a pump control unit 72, a PCU control unit 74, a valve control unit 76, a torque determination unit 78, a stopped-state determination unit 80, and an abnormality determination unit 82. The acquisition unit 68, the timing unit 70, the pump control unit 72, the PCU control unit 74, the valve control unit 76, the torque determination unit 78, the stopped-state determination unit 80, and the abnormality determination unit 82 are realized by the computation unit 62 executing programs stored in the storage unit 64. At least a part of the acquisition unit 68, the timing unit 70, the pump control unit 72, the PCU control unit 74, the valve control unit 76, the torque determination unit 78, the stopped-state determination unit 80, and the abnormality determination unit 82 may be realized by an integrated circuit such as an application specific integrated circuit (ASIC) or a field-programmable gate array (FPGA). At least a part of the acquisition unit 68, the timing unit 70, the pump control unit 72, the PCU control unit 74, the valve control unit 76, the torque determination unit 78, the stopped-state determination unit 80, and the abnormality determination unit 82 may be realized by an electronic circuit including a discrete device.

The storage unit 64 is a computer-readable non-transitory tangible storage medium. The storage unit 64 includes a volatile memory (not illustrated) and a non-volatile memory (not illustrated). The volatile memory is, for example, a random access memory (RAM). The non-volatile memory is, for example, a read only memory (ROM), a flash memory, or the like. Data and the like are stored in, for example, the volatile memory. Programs, tables, maps, and the like are stored, for example, in the non-volatile memory. At least a part of the storage unit 64 may be included in the processor, the integrated circuit, or the like as described above.

The acquisition unit 68 acquires various types of information from outside the computation unit 62. For example, the acquisition unit 68 acquires information indicating current value from the current sensor 52. This information is referred to as current information. The acquisition unit 68 acquires information indicating the rotational speed from the rotational speed sensor 54. This information is referred to as rotational speed information. The acquisition unit 68 acquires information indicating the pressure value from the pressure sensor 56. This information is referred to as pressure information. The timing unit 70 measures time.

The pump control unit 72 controls the operation of the fuel pump 14. The pump control unit 72 outputs a control signal to the fuel pump driver 66. The fuel pump driver 66 supplies electric power to the fuel pump 14 in accordance with the control signal.

The PCU control unit 74 performs switching control of the switching elements 48 by outputting control signals to the switching elements 48 provided in the PCU 38. The PCU control unit 74 performs the switching control, thereby changing the torque of the power generator 22, and as a result, electric power output from the power generator 22 is changed.

The valve control unit 76 outputs a control signal to the shutoff valve 16 to control opening and closing of the shutoff valve 16. The opening control of the shutoff valve 16 performed by the valve control unit 76 is control for establishing communication between the fuel supply path 18 connected to the fuel pump 14 and the fuel supply path 18 connected to the gas turbine engine 20. The closing control of the shutoff valve 16performed by the valve control unit 76 is control for cutting off the supply of fuel to the gas turbine engine 20.

The torque determination unit 78 determines whether or not the motoring torque of the power generator 22 is less than a predetermined torque threshold, after the control for cutting off the supply of fuel to the gas turbine engine 20 has been executed. When the torque determination unit 78 determines that the motoring torque of the power generator 22 is less than the torque threshold, the stopped-state determination unit 80 determines whether or not the gas turbine engine 20 has reached a stopped state. When the stopped-state determination unit 80 determines that the gas turbine engine 20 has not reached the stopped state, the abnormality determination unit 82 determines that an abnormality exists in the shutoff valve 16.

### 4. Inspection Process of Shutoff Valve 16

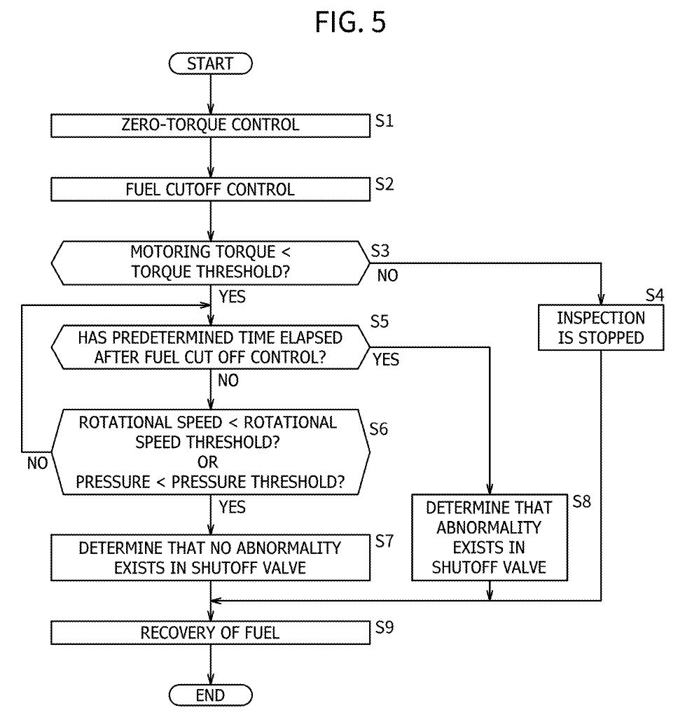

FIG. 5 is a flowchart of an inspection process of the shutoff valve 16. The inspection process of the shutoff valve 16is performed when movement of the moving object 100 is completed and the gas turbine engine 20 is stopped. Before the gas turbine engine 20 is stopped, an idling operation of the gas turbine engine 20 is performed. A state of the gas turbine engine 20 in which the idling operation is performed is referred to as an idling state. When the idling operation of the gas turbine engine 20 is being performed, the computation unit 62 performs an inspection process of the shutoff valve 16 described below.

In the inspection of the shutoff valve 16 described below, the computation unit 62 determines whether or not an abnormality exists in the shutoff valve 16 based on a result of whether or not the gas turbine engine 20 has reached a stopped state after actuation of the shutoff valve 16.

In step S1, the PCU control unit 74 starts zero-torque control. The zero-torque control is a control mode in which the switching elements 48 of the PCU 38 are controlled in a manner so that the torque of the power generator 22 becomes zero. Specifically, the control mode controls a current component contributing to torque (q-axis current) to be zero. By causing torque of the power generator 22 to become zero, torque of the output shaft 32 of the gas turbine engine 20 becomes zero.

In step S2, the valve control unit 76 performs fuel cutoff control. When the valve control unit 76 performs the fuel cutoff control, a control signal is output to the shutoff valve 16. If the shutoff valve 16 is not in failure, the shutoff valve 16 operates in accordance with the control signal. Here, the shutoff valve 16operates to close the fuel supply path 18, and cuts off the flow of fuel in the fuel supply path 18.

When the fuel cutoff control is started (when the shutoff valve 16 is actuated), the timing unit 70 starts measuring an elapsed time.

In step S3, the torque determination unit 78 compares the motoring torque of the power generator 22 with the torque threshold. The torque threshold is stored in the storage unit 64 in advance. In step S3, the torque determination unit 78 compares the motoring torque with the torque threshold for the following reasons.

In step S1, the torque of the power generator 22 is expected to become zero by the PCU control unit 74 starting the zero-torque control. However, a motoring torque may be generated in the power generator 22 due to operation timing deviations of the switching elements 48 in the PCU 38. When the powering torque is larger than a predetermined value (torque threshold), a long time is required until the output shaft 32 of the gas turbine engine 20 stops. If the shutoff valve 16is inspected in a state where a large motoring torque is generated in the power generator 22, there is a possibility that an erroneous determination that "the shutoff valve 16 is abnormal" is made even though the shutoff valve 16 is normal. In the present embodiment, in order to prevent such an erroneous determination, the inspection of the shutoff valve 16 is not performed when the motoring torque larger than the torque threshold is generated.

The torque determination unit 78 calculates the motoring torque of the power generator 22 based on the current information acquired by the acquisition unit 68. If the motoring torque of the power generator 22 is less than the torque threshold (step S3: YES), the process proceeds to step S5. On the other hand, when the motoring torque of the power generator 22 is equal to or greater than the torque threshold (step S3: NO), the process proceeds to step S4.

When the power generator 22 is in a motoring state, rates of decrease in rotational speeds of the gas turbine engine 20 and the power generator 22 are low. Therefore, there is a possibility that the inspection of the shutoff valve 16 is not completed even after a predetermined time (described later) has elapsed from the start of the inspection. By determining whether or not to continue the inspection based on the motoring torque as in step S3, the inspection of the shutoff valve 16 can be finished in a predetermined time.

When the process proceeds from step S3 to step S4, the abnormality determination unit 82 stops the inspection of the shutoff valve 16. Thus, the inspection of the shutoff valve 16 is not performed when the moving object 100 is stopped in this instance. The inspection of the shutoff valve 16is performed when the moving object 100 is stopped next time.

When the process proceeds from step S3 to step S5, the timing unit 70 determines whether or not a predetermined time has elapsed. The predetermined time is a time required for the gas turbine engine 20 to reach a predetermined stopped state after the fuel cutoff control is performed. The predetermined time is determined in advance and stored in the storage unit 64. The predetermined stopped state is set as a determination condition for the next step S6. When the predetermined time has elapsed since the fuel cutoff control was performed (step S5: YES), the process proceeds to step S8. On the other hand, when the predetermined time has not elapsed since the fuel cutoff control was performed (step S5: NO), the process proceeds to step S6.

When the process proceeds from step S5 to step S6, the stopped-state determination unit 80 determines whether or not the gas turbine engine 20 has reached the stopped state. The stopped state may be a state in which the gas turbine engine is fully stopped or a state in which the gas turbine engine is in the course of reaching the fully stopped state. Whether or not the gas turbine engine 20 has reached the stopped state can be determined based on the rotational speed of the output shaft 32 of the gas turbine engine 20 or the pressure at the outlet 34 of the compressor 26. When the stopped state means the fully stopped state, the rotational speed is zero and the pressure is atmospheric pressure. When the stopped state means a state in the course of reaching the fully stopped state, the rotational speed is a rotational speed corresponding to the predetermined time, and the pressure is a pressure corresponding to the predetermined time.

For example, the stopped-state determination unit 80 acquires the rotational speed of the output shaft 32 of the gas turbine engine 20 based on the rotational speed information acquired by the acquisition unit 68. The stopped-state determination unit 80 compares the rotational speed of the output shaft 32 of the gas turbine engine 20 with a rotational speed threshold. The rotational speed threshold is stored in advance in the storage unit 64.

Alternatively, the stopped-state determination unit 80 acquires the pressure at the outlet 34 of the compressor 26 based on the pressure information acquired by the acquisition unit 68. The stopped-state determination unit 80 compares the pressure at the outlet 34 of the compressor 26 with a pressure threshold. The pressure threshold is stored in the storage unit 64 in advance.

When the rotational speed is less than the rotational speed threshold or when the pressure is less than the pressure threshold (step S6: YES), the process proceeds to step S7. In this case, the gas turbine engine 20 has reached the stopped state. On the other hand, when the rotational speed is equal to or higher than the rotational speed threshold and the pressure is equal to or higher than the pressure threshold (step S6: NO), the process returns to step S5. In this case, the gas turbine engine 20 has not reached the stopped state.

In step S6, it may be determined whether the gas turbine engine 20 has reached the stopped state based on both the rotational speed of the output shaft 32 of the gas turbine engine 20 and the pressure at the outlet 34 of the compressor 26.

When the process proceeds from step S6 to step S7, the abnormality determination unit 82 determines that "no abnormality exists in the shutoff valve 16". The abnormality determination unit 82 transmits the determination result (inspection result) to the outside of the control device 60. For example, the abnormality determination unit 82 may transmit information indicating the determination result to an overall control device (not illustrated) that integrally manages and controls operation of the moving object 100. Alternatively, the abnormality determination unit 82 may transmit information indicating the determination result to an external server (not illustrated) that manages maintenance information of the moving object 100. Alternatively, the abnormality determination unit 82 may transmit information indicating the determination result to a portable terminal (not shown) of the user. Alternatively, the abnormality determination unit 82 may transmit information indicating the determination result to a display device (not shown). The display device displays the determination result.

When the process proceeds from step S5 to step S8, the abnormality determination unit 82 determines that "an abnormality exists in the shutoff valve 16". As in step S7, the abnormality determination unit 82 transmits the determination result (inspection result) to the outside of the control device 60.

When the process transitions from one of step S4, step S7, or step S8 to step S9, the valve control unit 76 operates the shutoff valve 16 in a direction opposite to that in step S2. The shutoff valve 16operates to open the fuel supply path 18 to allow flowing of fuel through the fuel supply path 18. Next, the pump control unit 72 rotates the fuel pump 14 in the direction opposite to the normal direction, thereby recovering the fuel remaining in the fuel supply path 18. The inspection process of the shutoff valve 16is thus completed.

In the above embodiment, when the motoring torque is less than the torque threshold, determination of whether the shutoff valve 16 has an abnormality is performed. According to the above embodiment, in the inspection of the shutoff valve 16, cases in which it is erroneously determined that "an abnormality exists in the shutoff valve" due to the motoring torque are reduced. According to the above embodiment, it is possible to suppress a decrease in accuracy of inspection of the shutoff valve 16.

According to the above embodiment, since the fuel remaining in the fuel supply path 18 is recovered after the inspection of the shutoff valve 16 is completed, it is possible to suppress a problem caused by the fuel remaining in the fuel supply path 18.

According to the above embodiment, the inspection of the shutoff valve 16 and the stop of the gas turbine engine 20 can be performed seamlessly.

### 5. Modifications

In the above embodiment, the predetermined time used in step S5 is the time required for the gas turbine engine 20 to reach a predetermined stopped state after the fuel cutoff control is performed. The predetermined time may be another time period. For example, as described below, the predetermined time may be a time period that is capable of suppressing leakage of fuel from the fuel supply path 18.

During a period from closure of the shutoff valve 16 until recovery of the fuel, fuel remaining in the fuel supply path 18 (nozzle) connected to the combustor 28 of the gas turbine engine 20 leaks into the combustor 28 due to gravity. Since the pressure inside the combustor 28 (the compressor outlet pressure) is high for a certain period after the gas turbine engine 20 is stopped, fuel in the fuel supply path 18 does not leak. On the other hand, when the gas turbine engine 20 is completely stopped and the pressure in the combustor 28 decreases, leakage of fuel can no longer be suppressed. If inspection of the shutoff valve 16and recovery of fuel can be completed within a predetermined time, fuel can be recovered from the fuel supply path 18 while the pressure in the combustor 28 remains high. When a time required for the gas turbine engine 20 to reach a predetermined stopped state after the fuel cutoff control is performed is shorter than a time until fuel remaining in the fuel supply path 18 (nozzle) leaks into the combustor 28 due to gravity, as a result, an effect of suppressing leakage of fuel into the fuel supply path 18 can also be obtained.

The inspection process of the shutoff valve 16 may be performed at a timing other than when the moving object 100 is stopped. For example, even when the moving object 100 is moving, the gas turbine engine 20 may be stopped. The inspection process of the shutoff valve 16 may be performed at this timing.

### 6. Supplementary Notes

The following Supplementary Notes are further disclosed in relation to the above embodiments.

### Supplementary Note 1

The control device (60) of the present disclosure is the control device provided in the power generation system (10) including the power generator (22), the gas turbine engine (20) that drives the power generator, and the power conversion device (38) that converts AC power output from the power generator into DC power, the control device including: the valve control unit (76) that controls the shutoff valve (16) to cut off supply of fuel to the gas turbine engine; the torque determination unit (78) that determines whether or not the motoring torque of the power generator is less than a predetermined torque threshold, after control to cut off the supply of fuel has been performed; the stopped-state determination unit (80) that determines whether or not the gas turbine engine has reached a stopped state in a case where the torque determination unit determines that the motoring torque of the power generator is less than the torque threshold; and the abnormality determination unit (82) that determines that an abnormality exists in the shutoff valve in a case where the stopped-state determination unit determines that the gas turbine engine has not reached the stopped state.

In the above configuration, when the motoring torque is less than the torque threshold, determination of whether or not an abnormality exists in the shutoff valve is performed. According to the above configuration, in the inspection of the shutoff valve, cases where it is erroneously determined that "an abnormality exists in the shutoff valve" due to the motoring torque are reduced. According to the above configuration, it is possible to suppress a decrease in inspection accuracy of the shutoff valve. With the above configuration, the number of shutoff valve replacements is reduced, thereby reducing maintenance time and cost of the gas turbine engine.

### Supplementary Note 2

In the control device according to Supplementary Note 1, the stopped-state determination unit may determine that the gas turbine engine has not reached the stopped state, in a case where the gas turbine engine does not reach the stopped state for a predetermined time or more.

### Supplementary Note 3

In the control device according to Supplementary Note 1, the stopped state determination unit may determine that the gas turbine engine is in the stopped state, when the rotational speed of the gas turbine engine is less than the predetermined rotational speed threshold or when the pressure at the outlet (34) of the compressor (26) provided in the gas turbine engine is less than the predetermined pressure threshold.

### Supplementary Note 4

In the control device according to Supplementary Note 1, the abnormality determination unit may stop determining whether or not an abnormality exists in the shutoff valve, when the torque determination unit determines that the motoring torque of the power generator is equal to or greater than the torque threshold.

When the power generator is in a motoring state, rates of decrease in rotational speeds of the gas turbine engine and the power generator are low. Therefore, there is a possibility that the inspection of the shutoff valve is not completed even after a predetermined time has elapsed from the start of the inspection. By determining whether or not to continue the inspection based on the motoring torque as in the above configuration, the inspection of the shutoff valve can be finished in a predetermined time.

### Supplementary Note 5

The control device according to Supplementary Note 1 may further include the pump control unit (72) configured to control the fuel pump (14) that pumps fuel to the gas turbine engine side by forward rotation and recovers fuel from the gas turbine engine side by reverse rotation, wherein the pump control unit may cause the fuel pump to perform reverse rotation after the determination of whether or not an abnormality exists in the shutoff valve has been performed.

According to the above configuration, since the fuel remaining in the fuel supply path is recovered after the inspection of the shutoff valve is completed, it is possible to suppress a problem caused by fuel remaining in the fuel supply path.

### Supplementary Note 6

The control device according to Supplementary Note 1 may further include the power conversion control unit (74) configured to control the power conversion device, wherein the valve control unit may be configured to control the shutoff valve to cut off supply of fuel to the gas turbine engine, in a state where the gas turbine engine is in an idling state and the power conversion control unit is controlling the power conversion device such that the DC power output from the power conversion device becomes zero.

According to the above configuration, the inspection of the shutoff valve and stop of the gas turbine engine can be performed seamlessly.

### Supplementary Note 7

The moving object (100) of the present disclosure includes the power generation system including the control device according to any one of Supplementary Notes 1 to 6.

### Supplementary Note 8

The control method of the present disclosure is the control method for the power generation system including the power generator, the gas turbine engine that drives the power generator, and the power conversion device that converts alternating-current (AC) power output from the power generator into direct-current (DC) power, the control method including: the valve control step (step S2) of causing one or more processors to control the shutoff valve to thereby cut off supply of fuel to the gas turbine engine; the torque determination step (step S3) of causing the one or more processors to determine whether or not the motoring torque of the power generator is less than the predetermined torque threshold, after the valve control step has been performed; the stopped-state determination step (step S6) of causing the one or more processors to determine whether or not the gas turbine engine has reached the stopped state, when it is determined in the torque determination step that the motoring torque of the power generator is less than the torque threshold; and the abnormality determination step (step S8) of causing the one or more processors to determine that an abnormality exists in the shutoff valve, when it is determined in the stopped-state determination step that the gas turbine engine has not reached the stopped state.

### Supplementary Note 9

The program according to the present disclosure causes a computer to execute the control method according to Supplementary Note 8.

Although the present disclosure has been described in detail, the present disclosure is not limited to the above-described embodiments. In these embodiments, various additions, replacement, changing, partial deletions, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. A control device provided in a power generation system including a power generator, a gas turbine engine that drives the power generator, and a power conversion device that converts alternating-current power output from the power generator into direct-current power, the control device comprising:
one or more processors that execute computer-executable instructions stored in a memory,
wherein the one or more processors execute the computer-executable instructions to cause the control device to:
control a shutoff valve to cut off supply of fuel to the gas turbine engine;
determine whether or not a motoring torque of the power generator is less than a torque threshold that has been predetermined, after controlling of the shutoff valve to cut off the supply of fuel has been performed;
determine whether or not the gas turbine engine has reached a stopped state, in a case where it is determined that the motoring torque of the power generator is less than the torque threshold; and
determine that an abnormality exists in the shutoff valve, in a case where it is determined that the gas turbine engine has not reached the stopped state.

2. The control device according to claim 1, wherein
the one or more processors execute the computer-executable instructions to cause the control device to:
determine that the gas turbine engine has not reached the stopped state, in a case where the gas turbine engine does not reach the stopped state for a predetermined time or more.

3. The control device according to claim 1, wherein
the one or more processors execute the computer-executable instructions to cause the control device to:
determine that the gas turbine engine is in the stopped state, in a case where a rotational speed of the gas turbine engine is less than a predetermined rotational speed threshold or in a case where a pressure at an outlet of a compressor provided in the gas turbine engine is less than a predetermined pressure threshold.

4. The control device according to claim 1, wherein
the one or more processors execute the computer-executable instructions to cause the control device to:
stop determining whether or not an abnormality exists in the shutoff valve, in a case where it is determined that the motoring torque of the power generator is equal to or greater than the torque threshold.

5. The control device according to claim 1, wherein
the one or more processors execute the computer-executable instructions to cause the control device to:
control a fuel pump configured to pump fuel toward the gas turbine engine by rotating in a forward direction and to recover fuel from the gas turbine engine by rotating in a reverse direction, and
wherein the one or more processors cause the control device to rotate the fuel pump in the reverse direction after determination of whether or not an abnormality exists in the shutoff valve has been performed.

6. The control device according to claim 1, wherein
the one or more processors execute the computer-executable instructions to cause the control device to:
control the shutoff valve to cut off the supply of fuel to the gas turbine engine, in a state where the gas turbine engine is in an idling state and the power conversion device is controlled in a manner so that the direct-current power output from the power conversion device becomes zero.

7. A moving object comprising a power generation system including the control device according to claim 1.

8. A control method for a power generation system including a power generator, a gas turbine engine that drives the power generator, and a power conversion device that converts alternating-current power output from the power generator into direct-current power, the control method comprising:
causing one or more processors to control a shutoff valve to thereby cut off supply of fuel to the gas turbine engine;
causing the one or more processors to determine whether or not a motoring torque of the power generator is less than a torque threshold that has been predetermined, after the controlling of the shutoff valve to thereby cut off the supply of fuel has been performed;
causing the one or more processors to determine whether or not the gas turbine engine has reached a stopped state, in a case where it is determined, in the determining regarding the motoring torque, that the motoring torque of the power generator is less than the torque threshold; and
causing the one or more processors to determine that an abnormality exists in the shutoff valve, in a case where it is determined, in the determining regarding the gas turbine engine, that the gas turbine engine has not reached the stopped state.

9. A non-transitory computer-readable storage medium storing a program for causing a computer to execute the control method according to claim 8.
